(19) United States
(12) Patent Application Publication
(10) Pub. No.: US 2020/0211056 A1
(43) Pub. Date: Jul. 2, 2020

(54) SYSTEMS, METHODS AND ARTICLES FOR SELL-SIDE OPTIMIZATION OF CONTENT PLACEMENT IN LINEAR MEDIACASTS

(71) Applicant: WideOrbit Inc., San Francisco, CA (US)

(72) Inventors: Brian Thoman, Everett, WA (US); Sai-Ming Li, Issaquah, WA (US); Ian P. Ferreira, Issaquah, WA (US)

(21) Appl. No.: 16/232,734

(22) Filed: Dec. 26, 2018

(51) Int. Cl. G06Q 30/02; H04N 21/262; H04N 21/81

(52) U.S. Cl. CPC G06Q 30/0249; G06Q 30/0206; H04N 21/812; G06Q 30/0247; H04N 21/26241; G06Q 30/0242

(57) ABSTRACT

Systems, methods and articles for automating and optimizing the selling of spots in mediacasts to maximize revenue uplift for sellers or achieve other goals in ways that were previously difficult or impossible. An autonomous proposal optimizer system is provided where sellers can optimize the number of spots to offer to buyers based on various optimization criteria that may be specified by the seller, and subject to constraints imposed by the buyer. The optimized selection of spots to offer may be presented using a heat map that allows the seller to quickly identify the number of spots to offer. The system may then send the proposal to the buyer to allow the buyer to purchase the spots offered in the generated optimized proposal.

### BACKGROUND

### Technical Field

The present disclosure relates the field of computer technology, and more particularly, to computer systems and methods that facilitate the delivery of content to consumers.

### Description of the Related Art

Content providers such as radio stations and networks, television stations and networks, and Webcasters provide programming including content which is the subject of programming. Content providers' delivery of content is often via broadcasts or Webcasts (collectively, “mediacasts”). While content providers may employ repeaters and the like, broadcasts are typically limited in range to a geographic region.

Programming often includes advertisements interspersed with the subject matter of the programming. The advertisements may occur in segments or slots sometimes referred to as “ad breaks.” Content providers typically sell advertising time to generate revenue to fund operation, as well as generate profits, where the content provider is a commercial entity rather than a nonprofit entity. Given that most broadcasts are local in nature or extent, content providers often carry advertisements and other material which is of a somewhat local or parochial interest. For example, a local chain may place advertisements with a local broadcaster since the audience targeted by the local chain is also often local and local advertising tends to be less expensive than regional or national advertising.

New approaches that automate the various activities related to buying, selling and placement of new materials, for instance, advertisements, in mediacasts are desirable.

### BRIEF SUMMARY

A system to optimize advertisement placement in linear mediacasts for a seller of advertisements may be summarized as including at least one nontransitory processor-readable storage medium that stores at least one of instructions or data; and at least one processor communicatively coupled to the at least one nontransitory processor-readable storage medium, in operation, the at least one processor: receives a request for an availability proposal for advertisement placement opportunities from a buyer, the request for the availability proposal including request criteria; retrieves availability proposal information; determines an optimized number of advertisement spots to offer to the buyer for each of a plurality of programs in each of one or more weeks, wherein, to determine the optimized number of advertisement spots to offer, the at least one processor: generates an objective function that has as an objective the maximization of expected revenue uplift for the seller, the objective function having as decision variables the number of advertisement spots to offer for each of the plurality of programs in each of the one or more weeks; generates one or more constraints defined by at least one of the request criteria or the availability proposal information; and determines respective values for the decision variables that maximize the objective function subject to the one or more constraints; presents, via a seller-facing interface, the determined values for the decision variables as the optimized number of advertisement spots to offer for each of a plurality of programs for each of the one or more weeks; and sends an availability proposal to the buyer over a communication network, the availability proposal indicating the determined optimized number of advertisement spots offered.

The objective function may include a linear objective function. The objective function may have an objective of rewarding proposed spots that have relatively few known or expected orders. The objective function may have an objective of rewarding proposed spots that increase diversity with respect to at least one of daypart, week, or spot length. The one or more constraints may include a constraint relating to an advertising impact goal of the buyer indicated in the request criteria. The one or more constraints may include a plurality of constraints relating to daypart advertising impact goals of the buyer indicated in the request criteria. The one or more constraints may include a constraint relating to a budget of the buyer indicated in the request criteria. The one or more constraints may include a plurality of constraints relating to daypart budgets of the buyer indicated in the request criteria. The one or more constraints may include a constraint relating to a maximum number of spots per half hour indicated in the request criteria. The request criteria may include one or more of a number of weeks to include in the availability proposal, eligible dayparts, eligible days, a budget, an advertising impact goal, a cost per rating point target, or spot length criteria. The availability proposal information may include one or more of a rate for each program or a rating for each program. The availability proposal information may include available demand forecast information for all eligible spots. The available demand forecast information may be based at least in part on available orders and a rate guide for each eligible spot. The available demand forecast information may be based at least in part on a global reserve price. The availability demand forecast information may be determined based on the rates and spot lengths of all of the other orders that are eligible to be placed in the eligible spot. At least one of the request criteria or the availability proposal information may specify a maximum number of spots that can be offered for each program per day. At least one of the request criteria or the availability proposal information may specify a maximum number of spots that can be offered for each half-hour. At least one of the request criteria or the availability proposal information may specify a maximum number of spots that can be offered for each program per week. The availability proposal information may specify at least one of: a configurable maximum number of spots that can be offered for each program per day; or a configurable maximum number of spots that can be offered for each program per week. The objective function may account for opportunity cost to maximize the expected revenue uplift for the seller. The request criteria of the availability request may specify at least one of hiatus date criteria, daypart criteria, program criteria, exclusion criteria, spot length criteria, and the one or more constraints accounts for the specified criteria.

A method of optimizing advertisement placement in linear mediacasts for a seller of advertisements may be summarized as including receiving, by at least one processor, a request for an availability proposal for advertisement placement opportunities from a buyer, the request for the availability proposal including request criteria; retrieving, by the at least one processor, availability proposal information; determining, by the at least one processor, an optimized number of advertisement spots to offer to the buyer for each of a plurality of programs in each of one or more weeks by: generating, by the at least one processor, an objective function that has as an objective the maximization of expected revenue uplift for the seller, the objective function having as decision variables the number of advertisement spots to offer for each of the plurality of programs in each of the one or more weeks; generating, by the at least one processor, one or more constraints defined by at least one of the request criteria or the availability proposal information; and determining, by the at least one processor, respective values for the decision variables that maximize the objective function subject to the one or more constraints; presenting, by the at least one processor via a seller-facing interface, the determined values for the decision variables as the optimized number of advertisement spots to offer for each of a plurality of programs for each of the one or more weeks; and sending, by the at least one processor, an availability proposal to the buyer over a communication network, the availability proposal indicating the determined optimized number of advertisement spots offered.

Generating an objective function may include generating a linear objective function. Generating an objective function may include generating an objective function that has as an objective of rewarding proposed spots that have relatively few known or expected orders. Generating an objective function may include generating an objective function that has as an objective of rewarding proposed spots that increase diversity with respect to at least one of daypart, week, or spot length. Generating one or more constraints may include generating a constraint relating to an advertising impact goal of the buyer indicated in the request criteria. Generating one or more constraints may include generating a plurality of constraints relating to daypart advertising impact goals of the buyer indicated in the request criteria. Generating one or more constraints may include generating a constraint relating to a budget of the buyer indicated in the request criteria. Generating one or more constraints may include generating a plurality of constraints relating to daypart budgets of the buyer indicated in the request criteria. Generating one or more constraints may include generating a constraint relating to a maximum number of spots per half hour indicated in the request criteria. Receiving a request for an availability proposal may include receiving a request for an availability proposal that includes request criteria that includes one or more of a number of weeks to include in the availability proposal, eligible dayparts, eligible days, a budget, an advertising impact goal, a cost per rating point target, or spot length criteria. Retrieving availability proposal information may include retrieving availability proposal information that comprises one or more of a rate for each program or a rating for each program. Retrieving availability proposal information may include retrieving availability proposal information that comprises available demand forecast information for all eligible spots. Retrieving availability proposal information may include retrieving the available demand forecast information which is based at least in part on available orders and a rate guide for each eligible spot. Retrieving availability proposal information may include retrieving the available demand forecast information which is based at least in part on a global reserve price. The availability demand forecast information may be determined based on the rates and spot lengths of all of the other orders that are eligible to be placed in the eligible spot. At least one of the request criteria or the availability proposal information may specify a maximum number of spots that can be offered for each program per day. At least one of the request criteria or the availability proposal information may specify a maximum number of spots that can be offered for each half hour. At least one of the request criteria or the availability proposal information may specify a maximum number of spots that can be offered for each program per week. The availability proposal information may specify at least one of: a configurable maximum number of spots that can be offered for each program per day; or a configurable maximum number of spots that can be offered for each program per week. The objective function may account for opportunity cost to maximize the expected revenue uplift for the seller. The request criteria of the availability request may specify at least one of hiatus date criteria, daypart criteria, program criteria, exclusion criteria, spot length criteria, and the one or more constraints accounts for the specified criteria.

A nontransitory processor-readable storage medium that stores at least one of instructions or data, the at least one nontransitory processor-readable storage medium, when executed by at least one processor, may be summarized as causing the at least one processor to: receive a request for an availability proposal for advertisement placement opportunities from a buyer, the request for the availability proposal including request criteria; retrieve availability proposal information; determine an optimized number of advertisement spots to offer to the buyer for each of a plurality of programs in each of one or more weeks, wherein, to determine the optimized number of advertisement spots to offer, the at least one processor: generates an objective function that has as an objective the maximization of expected revenue uplift for the seller, the objective function having as decision variables the number of advertisement spots to offer for each of the plurality of programs in each of the one or more weeks; generates one or more constraints defined by at least one of the request criteria or the availability proposal information; and determines respective values for the decision variables that maximize the objective function subject to the one or more constraints; present, via a seller-facing interface, the determined values for the decision variables as the optimized number of advertisement spots to offer for each of a plurality of programs for each of the one or more weeks; and send an availability proposal to the buyer over a communication network, the availability proposal indicating the determined optimized number of advertisement spots offered.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a networked environment, including an automated advertisement purchase computer system communicatively coupled between sellers, such as terrestrial radio or television providers or Webcasters, and buyers, such as advertisers who have advertisements to place or who otherwise control placement of advertisements, according to one illustrated implementation.

FIG. 2 is a workflow diagram of portions of the networked environment of FIG. 1, showing an example workflow for a transaction utilizing the advertisement purchase computer system, according to one illustrated implementation.

FIG. 3 is a high level flow diagram showing a method of operating a proposal optimizer of an automated advertisement purchase system to generate an availability proposal that includes a plurality of offers for advertisement placement opportunities, according to one non-limiting illustrated implementation.

FIG. 4 is a lower level flow diagram showing a method of operating a proposal optimizer of an automated advertisement purchase system to determine an optimized number of advertisement spots to offer to a buyer for a plurality of programs in each of one or more weeks, according to one non-limiting illustrated implementation.

FIG. 5 is a screenshot of an example availability request user interface of an automated advertisement purchase system, according to one non-limiting illustrated implementation. FIGS. 6A-6B is a screenshot of an example new availability proposal user interface of an automated advertisement purchase system, according to one non-limiting illustrated implementation.

FIG. 7 is a screenshot of an example availability proposal optimizer user interface of an automated advertisement purchase system, according to one non-limiting illustrated implementation.

FIG. 8 is a schematic diagram of an example computing environment in which one or more systems and methods of the present disclosure may be implemented, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of automating and optimizing the selling of advertisements, or “spots,” to allow content providers (e.g., networks) to meet or exceed their goals in ways that were previously difficult or impossible. Selling television, radio or digital advertising has traditionally been a highly manual process and requires many participants to execute orders. Layering in audience and pricing data adds another level of complexity to the campaign execution workflow.

In conventional workflows, if an advertiser operates in 20 markets and wants to advertise locally in those markets, a representative of the advertiser contacts (e.g., calls, emails) multiple networks in each of the 20 markets to negotiate and purchase advertising. In this example, if the advertiser wants to inquire about or purchase advertising with 5 to 7 networks in each of the 20 markets, the advertiser would need to manually contact and negotiate with 100-150 networks, which is an extremely time consuming and inefficient process.

Implementations of the present disclosure are directed to computer-implemented systems and methods for providing an autonomous advertisement purchase system where buyers can automatically receive offers for advertisement placement opportunities simultaneously via a single interface, and the system can optimize selection of the received offers based on various optimization criteria that may be specified by the advertiser. Thus, the aforementioned manual and inefficient process is automated and provides optimization that was previously not possible using conventional workflows.

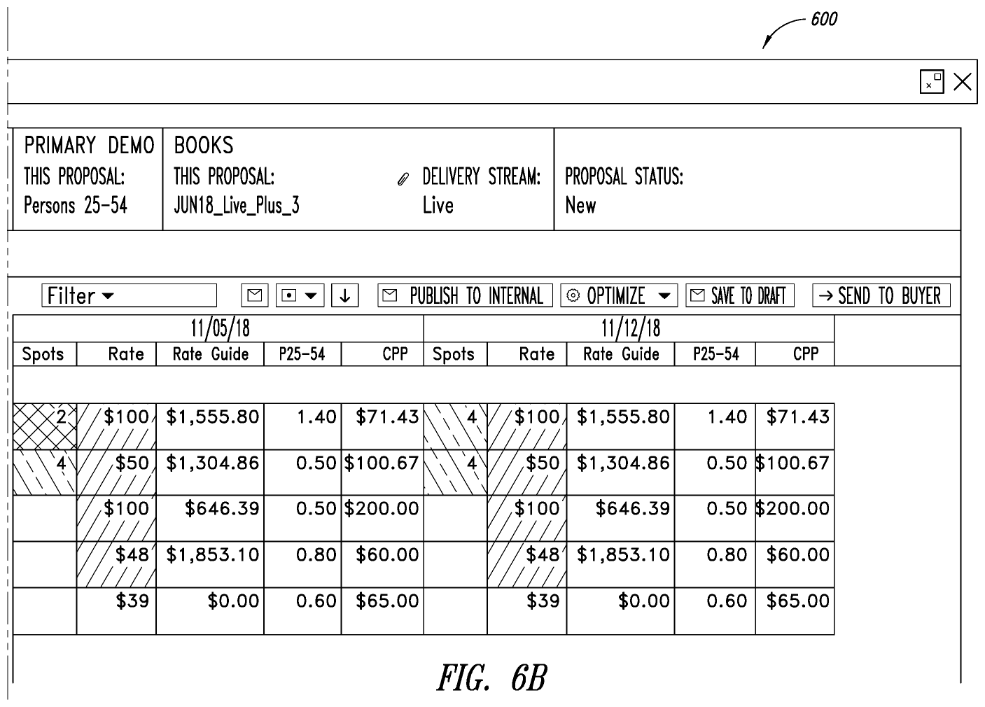

One of the key acts in the transaction process may be responding to a request for available spots, also referred to as an availability request or “avail request,” with a proposal by a seller. FIG. 5, discussed below, shows an example availability request received by a seller from a buyer. Based on the information provided in the availability request and other information, the seller provides the buyer with an availability proposal. An example availability proposal is shown in FIG. 6, discussed further below.

There is a significant amount of information provided in the seller's availability proposal, and previously many decisions had to be made when preparing a proposal. In at least some implementations discussed herein, systems and methods are provided that autonomously help the seller decide the number of spots to offer to a buyer such that the goals of the buyer are met and the revenue uplift of the seller is maximized. In at least some implementations, the systems and methods also provide diversity in the spots offered to meet the desired spot characteristics of the buyer or the seller.

In at least some implementations, a proposal optimizer is provided that solves a mathematical programming problem to determine the value of a set of decision variables to maximize an objective function subject to a set of constraints that the solution needs to satisfy. For example, decision variables may be the number of spots to offer in a proposal for each eligible day on each week of every program (or “line”) in a proposal offered by the seller. The objective function may maximize the expected revenue uplift for the seller. In at least some implementations, the objective function may also reward proposing spots in half hours where there are few known or expected hours. In at least some implementations, the objective function may reward the diversity of spots offered in terms of dayparts, weeks, and/or spot lengths, for example. Non-limiting examples of constraints may include daypart cost-per-point (CPP) goals of the buyer, daypart budgets of the buyer, or a maximum number of spots per half hour.

In at least some implementations, buyers and sellers can trade mediacast (e.g., broadcast, Webcast) advertisement inventory (e.g., direct or programmatically) at local, national, and/or worldwide levels. The types of media traded via may simultaneously include numerous types of media, including TV, cable, satellite, radio, outdoor, print, etc. Such programmatic advertising implements data-driven automation of audience-based advertising operations which inverts the industry standard in which marketers rely on show ratings to determine desirable audiences for the marketers' advertisements. Instead, with programmatic, marketers may use audience data to pipe advertising to optimal places. For example, marketers may use programmatic technology to reach a more specific set of consumers regardless of on which programs the advertisements appear.

In at least some implementations, the systems of the present disclosure seamlessly blend traditional linear media (e.g., TV, cable, satellite, radio, outdoor, print) sales practices with data-driven digital advertisement buying methods. In some implementations, the systems are fully automated seller-controlled advertisement purchase systems which connect local mediacasters (e.g., broadcasters, Webcasters, printed content providers) with new and existing demand sources and offer revenue management tools for optimizing yields across direct and programmatic channels. Transactions may be demand-led, which allows sellers to view the demand across the sellers' entire landscape of potentially available advertisement inventory. Further, in some implementations, the sellers may accept or reject bid responses from buyers without revealing price floors or available advertisement opportunities to any of the buyers.

In at least some implementations, the advertisement purchase systems disclosed herein interface with demand side platforms (DSPs) that make automated media advertisement purchases. Sellers enjoy seamless transaction workflow for getting advertisements from proposal, to publishing, and to billing that delivers a significant reduction in time spent on reconciliation and “make-goods” and streamlines processes for creative management and revenue management across direct and programmatic sales channels.

In some implementations, the advertisement purchase systems include powerful yield management tools that give participating sellers the power to retain full control of pricing floors and inventory allocation across direct and programmatic sales channels. The advertisement purchase systems may also honor all placement rules for delivery separation and automatic management of potential channel conflict across advertisements sold directly and through the advertisement purchase system.

The advertisement purchase systems may include a seller side platform (SSP) or console for sellers (e.g., broadcasters, Webcasters, printed content providers) and an advertiser-facing interface or console for demand side platform (DSP) entities to interface with the advertisement purchase systems. Through the SSP, sellers can access demand and make advertisement inventory available and accept or reject bid responses based on marketplace demand.

The advertiser-facing interface facilitates creative placement and reviewing for the buy side, and may have transcoding and approval tools for the sell side. For example, in some implementations, once an advertisement transaction is approved, the advertiser-facing interface sends the advertisement directly to a broadcaster's traffic system. In some implementations, the advertisement purchase system is a sell-side powered marketplace, which allows sellers to set price floors and to retain the right to accept or reject any offer which comes through the advertisement purchase system.

In some implementations, the advertisement purchase systems disclosed herein automate aspects of billing, reconciliation, and creative execution. In some implementations, the advertisement purchase systems may be integrated with advertisement management software and sales and traffic management systems.

In one or more implementations disclosed herein, the systems do not require sellers to offer particular day parts or times when advertisement inventory is available. That is, “carve-outs” are not required. Rather, buyers can extend offers for the entire roster or landscape for a particular channel for a particular period of time (e.g., mediacast day). Thus, sellers may peruse this demand and decide which offers to accept or not to accept.

As discussed further below, in some implementations, the advertisement inventory is bought and sold as canonical inventory units which group similar but discrete advertisement slots together. For example, for linear media an inventory unit may be defined as a specific channel, day and time period (e.g., 30 minutes). In at least some implementations, when the marketplace opens for a given mediacast day, the marketplace may issue requests for bids (RFBs) for all inventory units for that mediacast day. Buyers may price the inventory units and provide a bid for any of the inventory units. At a daily market close, the advertisement purchase may notify the buyers of the win/loss outcomes. In some implementations, the demand (e.g., bid responses) may be expressed for future slots but sellers may accept near publishing time (e.g., 10 seconds before airtime, 10 minutes before airtime).

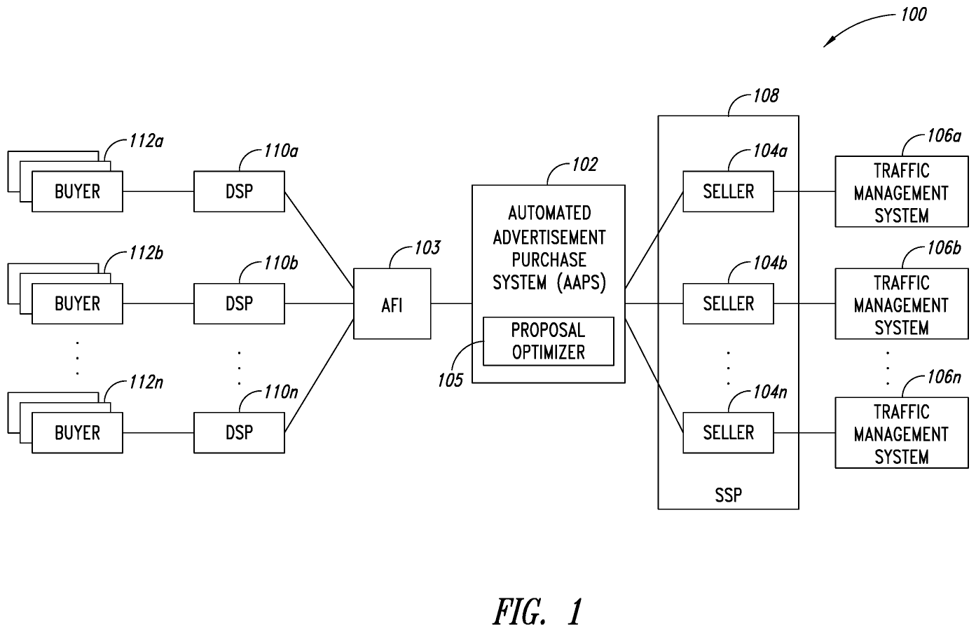

FIG. 1 shows an example networked environment 100 according to one illustrated implementation in which various apparatus, methods and articles described herein may operate. The environment 100 includes an advertisement purchase or exchange system 102 that includes a proposal optimizer module 105, discussed below, an advertiser-facing interface (AFI) 103, a number of sellers or content providers 104A-104N (collectively 104), traffic management systems 106A-106N (collectively 106), a supply side platform (SSP) 108, a number of demand side platforms (DSPs) 110A-110N (collectively 110), and a number of buyers 112A-112N (collectively 112), all communicatively coupled by one or more networks or other communications channels. The various components of the environment may be distributed or integrated in any number of ways. For example, in at least some implementations, two or more of the DSPs 110, AFI 103, automated advertisement purchase system 102, SSP 108 and traffic management system 106 may be integrated into a single platform provided by one or more entities.

The sellers 104 may take a variety of forms, for example, radio stations or broadcasters, television stations or broadcasters, other terrestrial or satellite broadcasters or multicasters (not shown), Webcasters, printed content (e.g., print media) providers, outdoor content (e.g., billboards) providers, etc. The sellers 104 may, or may not, own the content that they provide. The sellers 104 utilize the SSP 108 to access the advertisement purchase system 102 and may use the traffic management systems 106A-106N for traffic management. On the buy side, the buyers 112 (e.g., advertisers, agencies) may interface with the system 102 via the AFI 103 through the buyers' respective DSPs 110.

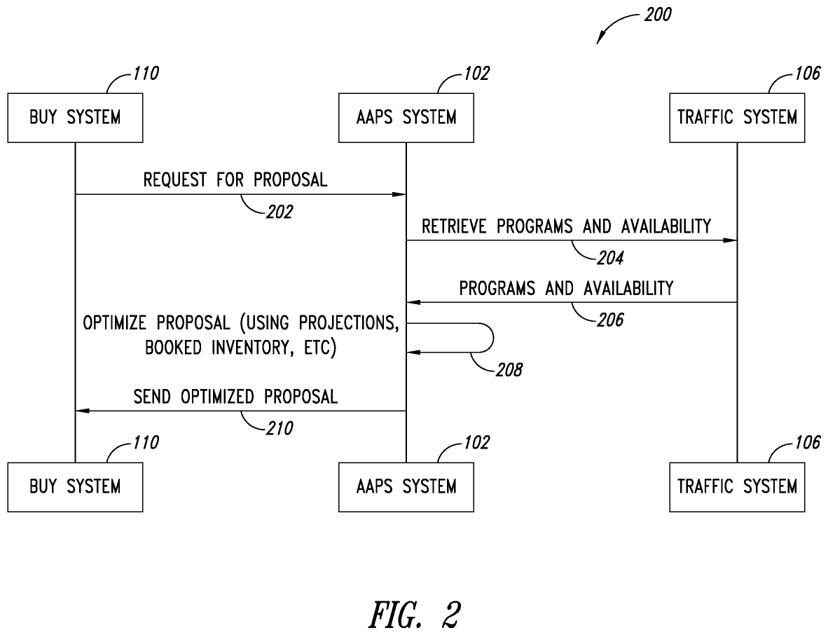

FIG. 2 shows a non-limiting example workflow 200 for implementing the automated advertisement purchase system 102 in the environment 100 of FIG. 1 between a buy system (e.g., DSP 110), the advertisement purchase system that includes the proposal optimizer 105, and the traffic management system 106. At 202, the buy system 110 sends a request for a proposal, also referred to as an “avail request,” to the automated advertisement purchase system 102. The avail request includes various request criteria, as discussed further below. At 204, the automated advertisement purchase system 102 retrieves programs and availability information from the traffic system 106. At 206, the traffic system 106 sends the requested programs and availability information to the automated advertisement purchase system 102. At 208, the proposal optimizer 105 of the automated advertisement purchase system 102 optimizes the proposal using projections, booked inventory, etc., as discussed further below. At 210, the automated advertisement purchase system 100 sends the optimized proposal to the buy system 110 for consideration by the buyer.

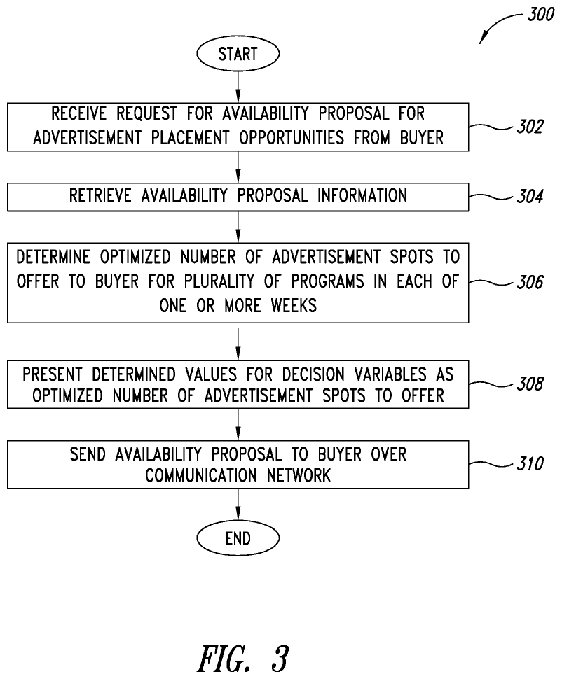

As shown in FIG. 3, the automated advertisement purchase system 102 may implement a method 300 that optimizes a proposal for a seller. At 302, the automated advertisement purchase system receives a request for an availability proposal (“avail request) for advertisement placement opportunities from a buyer. The request for the availability proposal may include request criteria. The request criteria may include one or more of a number of weeks to include in the availability proposal (“flight”), eligible dayparts, eligible days, a budget, an advertising impact goal, a cost per rating point (CPP) target, spot length criteria, a maximum number of spots that can be offered for each program per day, a maximum number of spots that can be offered for each half-hour, a maximum number of spots that can be offered for each program per week, hiatus date criteria, daypart criteria, program criteria, exclusion criteria, spot length criteria, etc.

As an example, a view avail request user interface 500 shown in FIG. 5 may be provided to the seller that allows the seller to review the various request criteria provided in the avail request received from the buyer. In the illustrated example shown in FIG. 5, the user interface 500 includes request criteria set by the buyer, such as flight dates, hiatus criteria, demographics, targeting, channels, books, dayparts, market goals (e.g., GRP goal), affiliate goals, spot length goals, daypart goals, weekly goals, or programs. These features allow the advertiser to select various criteria for their campaign. In other implementations, fewer or additional configurations or goals may be provided by the advertiser to define the particular features of a new avail request.

FIGS. 6A-6B show a new proposal user interface 600 that includes various information for a new proposal to be sent to a buyer. The new proposal includes a number of lines, one for each program, for each of one or more weeks that will be provided in the proposal responsive to the avail request. Each of lines includes program name, daypart, times and days, spot length, books, GRP, and total rate. For each week, each line includes the number of spots to offer to the buyer, the rate, the rate guide, a demographics factor, and CPP. As discussed above, the number of spots to offer are the decision variables that are optimized by the proposal optimizer.

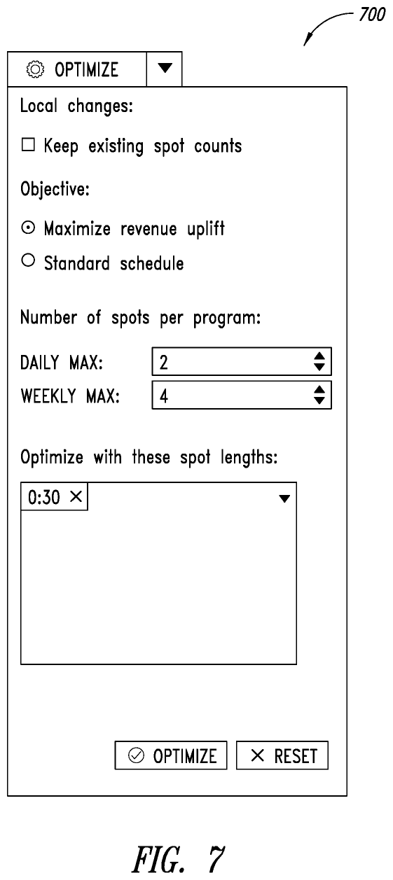

The user interface 600 also includes an “optimize” button that, when selected, provides a drop down optimizer user interface 700 shown in FIG. 7. The optimizer user interface 700 allows the user to select various optimization criteria, and includes an “optimize” button that causes the proposal optimizer 105 (FIG. 1) to optimize the number of spots to offer to the buyer for each line for each week. In the illustrated example, the optimizer user interface 700 allows the user to specify the maximum number of spots per program to offer per day and per week. The user interface 700 also allows the user to specify which spot lengths (e.g., 30 seconds, 15 seconds) to optimize. The user interface 700 also allows the user to specify whether to optimize with an objective of maximizing revenue uplift, or to optimize with a standard schedule as the objective. Selecting standard schedule may cause the proposal optimizer to select spots similar to those that would be manually selected by a user. Finally, the user interface 700 allows the user to specify that the optimizer should keep existing spot counts manually entered by the user, such that the optimizer ignores such spot counts during the optimization process.

At 304, the automated advertisement purchase system 102 may retrieve availability proposal information. As an example, the availability proposal information may include one or more of a rate for each program or a rating for each program. In at least some implementations, the availability proposal information may include available demand forecast information for all eligible spots. The available demand forecast information may be based at least in part on available orders and a rate guide for each eligible spot. In at least some implementations, the available demand forecast information may be based at least in part on a global reserve price. The availability demand forecast information may be determined based on the rates and spot lengths of all of the other orders that are eligible to be placed in the eligible spot. The availability proposal information may specify a maximum number of spots that can be offered for each program per day, a maximum number of spots that can be offered for each half hour, a maximum number of spots that can be offered for each program per week, or other criteria, such as criteria shown in the optimizer user interface 700 of FIG. 7.

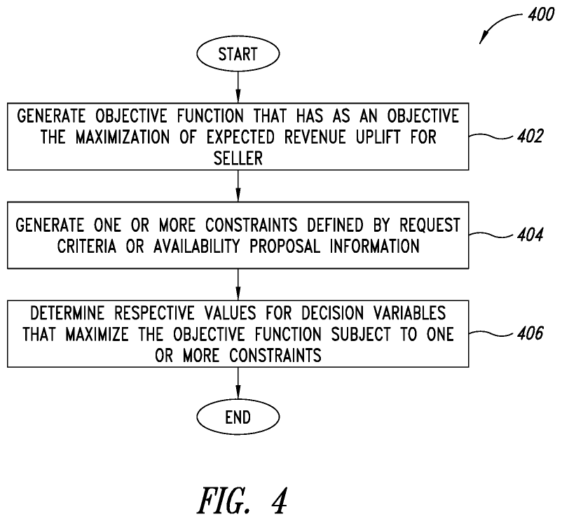

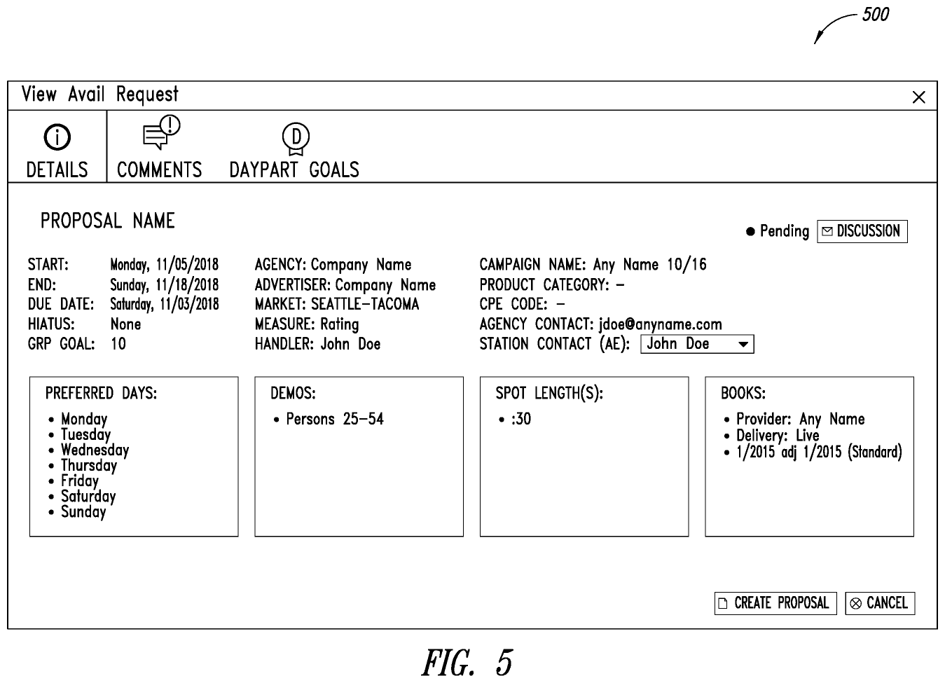

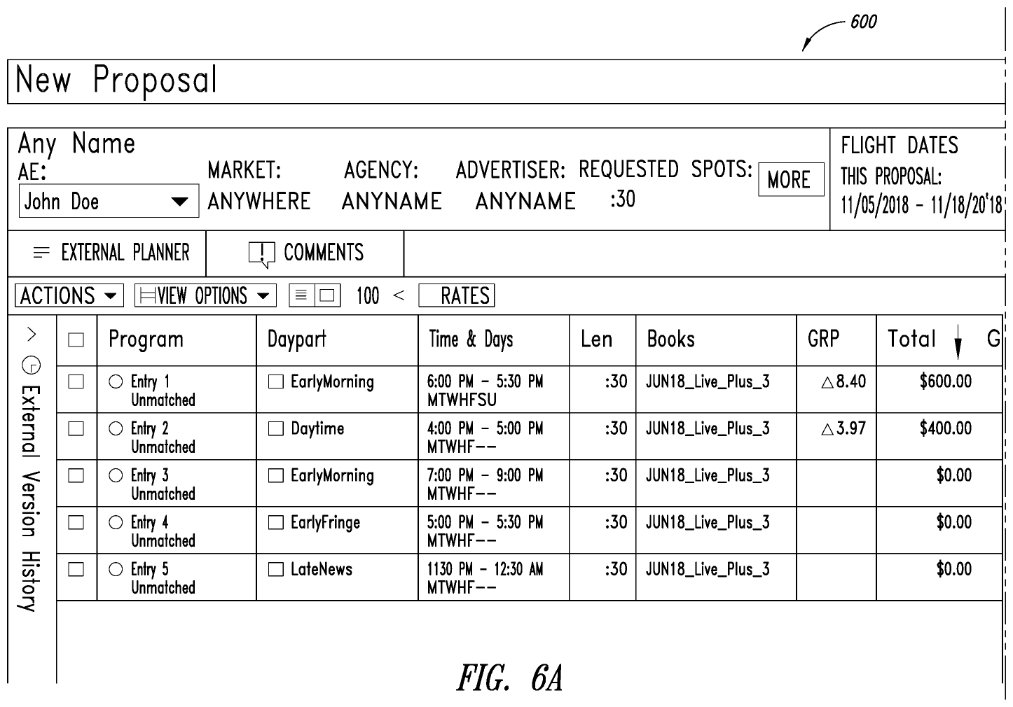

At 306, the automated advertisement purchase system 102 may determine an optimized number of advertisement spots to offer to the buyer for each of a plurality of programs in each of one or more weeks. For example, the system 102 may run the proposal optimizer 105 (FIG. 1) responsive to a user selecting the “optimize” button in the optimizer user interface 700. An example process 400 of determining an optimized number of advertisements spots to offer is shown in FIG. 4, discussed herein below.

At 308, the automated advertisement purchase system 102 may present the determined values for the decision variables as the optimized number of advertisement spots to offer for each of a plurality of programs for each of the one or more weeks. For instance, the system may update the spot counts shown in the new proposal user interface 600 of FIG. 6. As indicated by the different hatching of the boxes in FIG. 6, the entries in the spots column and rate column (and/or other columns) may be color coded to provide a “heat map” for the user to allow the user to quickly identify which spots to select based on the colors in addition to the values presented in the user interface. Further, the user may manually modify any of the optimized spot counts as desired.

At 310, the automated advertisement purchase system 102 may send the generated and optimized availability proposal to the buyer over a communication network so that the user may purchase any or all of the offered spots provided in the proposal.

FIG. 4 shows a method 400 of operating an automated advertisement purchase system 102 to determine an optimized number of advertisement spots to offer to the buyer for each of a plurality of programs in each of one or more weeks. The method begins at 402, wherein the automated advertisement purchase system generates an objective function that has as an objective the maximization of expected revenue uplift for the seller. The objective function may have as decision variables the number of advertisement spots to offer for each of the plurality of programs in each of the one or more weeks, as discussed above. As an example, the objective function may be a linear objective function. The objective function may additionally or alternatively have an objective of rewarding proposed spots that have relatively few known or expected orders. The objective function may additionally or alternatively have an objective of rewarding proposed spots that increase diversity with respect to at least one of daypart, week, or spot length, for example.

At 404, the automated advertisement purchase system generates one or more constraints defined by at least one of the request criteria or the availability proposal information. For example, the one or more constraints may include a constraint relating to an advertising impact goal (e.g., GRP goal) of the buyer indicated in the request criteria. The one or more constraints may include a plurality of constraints relating to daypart advertising impact goals of the buyer indicated in the request criteria. The one or more constraints may include a constraint relating to a budget of the buyer, a plurality of constraints relating to daypart budgets of the buyer, or a constraint relating to a maximum number of spots per half hour, day, week, program, etc.

At 406, the automated advertisement purchase system determines respective values for the decision variables that maximize the objective function subject to the one or more constraints. As an example, the automated advertisement purchase system may utilize a solver algorithm to determine the respective values for the decision variables that maximizes the objective function.

A detailed discussion of one or more implementations of the present disclosure is provided below. It should be appreciated that the particular implementation is provided as a non-limiting example and should not be interpreted as limiting the scope of the present disclosure.

In at least some implementations, the proposal optimizer 105 receives at least the following information as input: the number of lines (e.g., programs) and weeks to include in the proposal; for each line, the half hours and day of the week that spots can run; the rate and rating of each line; the buyer's overall budget; and the buyer's overall GRP goal.

The proposal optimizer 105 may also retrieve the available demand for all eligible spots in terms of the rate and the spot lengths of all of the other orders (“known orders”) that are eligible to air in those spots. Further, as discussed above, the proposal optimizer 105 may also receive a configurable cap on the number of spots that can be proposed for each line per day as well as per week, which avoids running advertisements too many times in the same program.

To decide whether to propose a specific spot to the buyer in the proposal, the proposal optimizer may determine the opportunity cost of giving up that spot. The opportunity cost may be represented by the revenue that could be generated if the same spot is offered to the best alternative buyer. Since, at the proposal generation time, not all orders for that spot are placed, the proposal optimizer implements demand forecasting to generate available demand forecast information that indicates an estimated demand for each of the eligible spots.

In at least some implementations, to implement demand forecasting the proposal optimizer takes into account the available or known orders for the spot considered. The proposal optimizer may also take into account the rate guide for the spot considered. As an example, the rate guide may be provided by an external source (e.g., Adlntel) or may be generated by a rate prediction model. In at least some implementations, the proposal optimizer may take into account a global reserve (floor) price as a fall back in case the above information does not exist or returns a price that is too low.

The opportunity cost may be defined based on the available orders as the average rate of all non-zero rate orders. Zero rate orders may be excluded as such orders are mostly bonus or makegood orders, which are not free and can be difficult to value. This is because it is desirable to set a higher reserve price early in the booking period to accommodate future demand in order to avoid a race to the bottom. As the proposal generation time get closer to the air date, the proposal optimizer may evolve the calculation to use a value that is closer to the minima of all non-zero rate bookings to represent the true opportunity cost.

Let hᵢⱼₖₕ denote the half hour for sᵢⱼₖₕ, which is the spot proposed for line i in week j, day k, and half hour h. Note that the variable sᵢⱼₖₕ can only take value in the set of non-negative integers Z^{≥}={0,1,2, . . . }. This set can be restricted to {0,1} if it is assumed that only one spot will be proposed per half hour, which is common practice in the industry. Suppose at the time of creating the proposal, there are N_{σijk} order lines σᵢⱼₖₕ₁, σᵢⱼₖₕ₂, . . . , σ_{ijkhN}_{_{σijk}}, each with the number φᵢⱼₖₕₗ of spots going to air during the half hour hᵢⱼₖₕ. Let the rate and 30 second equivalent spot length of order line σᵢⱼₖₕₗ be θᵢⱼₖₕₗ and μᵢⱼₖₕₗ, respectively.

The average rate for a 30 second spot during the hour hᵢⱼₖₕ based on existing order lines is given by:

$$\frac{{Σ}_{l} {θ}_{ijkhl} \times {μ}_{ijkhl} \times {ϕ}_{ijkhl}}{{Σ}_{l} {μ}_{ijkhl} \times {ϕ}_{ijkhl}}$$

The above formulation assumes that it is known in which half hour each existing order line will air its spots. In practice, orders may not be placed in the traffic log until a few weeks before the air date, for example. At proposal time, all that the proposal optimizer has is a set of order lines with eligible days, start time, end time, and spot count for each week. Thus, the proposal optimizer needs to deduce the expected demand at each half hour based on such information only. In order to do that, the proposal optimizer determines an effective normalized spot count for orders that have not been placed in the traffic log yet. In at least some implementations, an assumption is that the spots of each line can be placed in any of the eligible half hours with equal likelihood.

For a line l that has a spot eligible to air during half hour hᵢⱼₖₕ, its effective normalized spot count φᵢⱼₖₕₗ for hour hᵢⱼₖₕ is given by:

$${ϕ}_{ijkhl} = \frac{normalized spot length \times spot count}{number of eligible half hours}$$

For example, suppose a line l has a spot length of 15 seconds, and a spot count of two spots each week, where each week it is eligible to air during Monday and Sunday for a two-hour program. Then, its effective normalized spot count φᵢⱼₖₕₗ is given by:

$${ϕ}_{ijkhl} = \frac{\frac{15}{30} \times 2}{2 \times 4} = \frac{1}{8} = 0.125$$

When the proposal optimizer uses effective spot placed instead of actual spot placed, the spot length μᵢⱼₖₕₗ used for calculating the average rate is always one (1) as the proposal optimizer has already normalized the spot length to 30 seconds to get the effective spots place.

Let κᵢⱼₖₕ be the total capacity for the half hour hᵢⱼₖₕ. The available capacity γᵢⱼₖₕ during that half hour is given by:

$${γ}_{ijkh} = {κ}_{ijkh} - {\sum }_{l} {μ}_{ijkhl} \times {ϕ}_{ijkhl}$$

Further, let the rate guide for a 30 second spot during hour hᵢⱼₖₕ be ωᵢⱼₖₕ, and the global reserve price for a 30 second spot be τ. These two rates serve as reserves when there is not a lot of orders placed for the half hour under concern yet. The proposal optimizer considers the effective rate p′ᵢⱼₖₕ of a displaced spot to be:

$${p}_{ijkh}^{′} = max \{ \frac{{Σ}_{l} {θ}_{ijkhl} \times {μ}_{ijkhl} \times {ϕ}_{ijkhl}}{{Σ}_{l} {μ}_{ijkhl} \times {ϕ}_{ijkhl}} , {ω}_{ijkh} , τ \}$$

The opportunity cost for each unit of sᵢⱼₖₕ is 0 when the available capacity is larger than the spot length of the proposal line, and (eᵢ−γᵢⱼₖₕ) times the effective rate of a displaced spot, where eᵢ is the 30 second equivalent spot length for line i. This gives the following for the opportunity cost:

$${c}_{ijkh} = \{ \begin{matrix}0 & if {γ}_{ijkh} > {e}_{i} \\ ( {e}_{i} - {γ}_{ijkh} ) \times {p}_{ijkh}^{′} & otherwise\end{matrix}$$

To account for future demand that will exhaust the available capacity even when it is more than enough to accommodate the current proposal and simplify the integer programming problem formulation, the proposal optimizer may use the following definition for opportunity cost cᵢⱼₖₕ:

cᵢⱼₖₕ=(eᵢ−γᵢⱼₖₕ)×p′ᵢⱼₖₕ

This effectively discourages proposing spots in half hours where current demand is strong, even if the available capacity is enough to accommodate the new spot.

In practice, the total capacity κᵢⱼₖₕ is not known for most, if not all, half hours at the time a proposal is generated. Thus, the proposal optimizer estimates the total capacity κᵢⱼₖₕ using available knowledge. In at least some implementations, the total capacity κᵢⱼₖₕ may be used as a design parameter to adjust how much the seller would like to push the new proposal to half hours where demand is sparse. The lower κᵢⱼₖₕ is, the more aggressive the proposal optimizer will push spots of the new proposal to half hours where not much demand is available.

For a given set of proposed spots sᵢⱼₖₕ, we have:

$$R = {\sum }_{i , j , k , h} {s}_{ijkh} \times {r}_{i}$$

where R is the expected rating delivery for the proposal and rᵢ is the rating of each spot for line i in the proposal and assumes all spots have the same rating in a given line.

The opportunity cost to air sᵢⱼₖₕ spots for line i in week j and day k at half hour h is given by cᵢⱼₖₕ×sᵢⱼₖₕ.

The expected revenue uplift U for the proposal is then given by:

$$U = {\sum }_{i , j , k , h} ( {p}_{i} - {c}_{ijkh} ) \times {s}_{ijkh}$$

where pᵢ is the spot rate for line i in the proposal

The proposal optimizer also needs to enforce the constraint that caps the number of spots proposed for each half hour, which may be expressed as:

sᵢⱼₖₕ≤s̅ᵢⱼₖₕ

where s̅ᵢⱼₖₕ is the maximum number of spots allowed to propose for line i in week j, day k and half hour h. The optimization problem to solve for the optimal sᵢⱼₖₕ is given by the following:

$$Maximize$$

$$\begin{matrix}J = {\sum }_{i , j , k , h} ( {p}_{i} - {c}_{ijkh} ) \times {s}_{ijhk} \\ = {\sum }_{i , j , k , h} ( {p}_{i} - ( {e}_{i} - {γ}_{ijhk} ) \times {p}_{ijkh}^{′} ) \times {s}_{ijkh}\end{matrix}$$

$$Subject to$$

$${\sum }_{i , j , k , h} {s}_{ijkh} \times {r}_{i} > G$$

$${\sum }_{i , j , k , h} {s}_{ijkh} \times {p}_{i} \leq B$$

$${s}_{ijkh} < {\overline{s}}_{ijkh}$$

where J is the objective function, G is the GRP goal for the proposal, and B is the budget for the proposal. This is a linear integer programming problem and that may be solved using a solver or other analytical tool.

In at least some implementations, the formulations above may be extended to support scenarios where additional goals and constraints are desired. For example, the avail request may have hiatus date criteria, daypart criteria, program criteria, or any exclusion criteria. The proposal optimizer may support such avail requests by adding new constraints in the optimization problem to force the spot counts for the corresponding half hours to zero to satisfy such constraints. As another example, if the avail request has additional constraints such as spot length, weekly cap, etc., the proposal optimizer may add new constraints in the optimization problem to limit the sum of the spot counts corresponding to those dimensions to the cap. As another example, if there are additional goals, such as daypart goals, the proposal optimizer may add new constraints in the optimization problem to demand the sum of the spot counts corresponding to those dimensions to meet or exceed the goals.

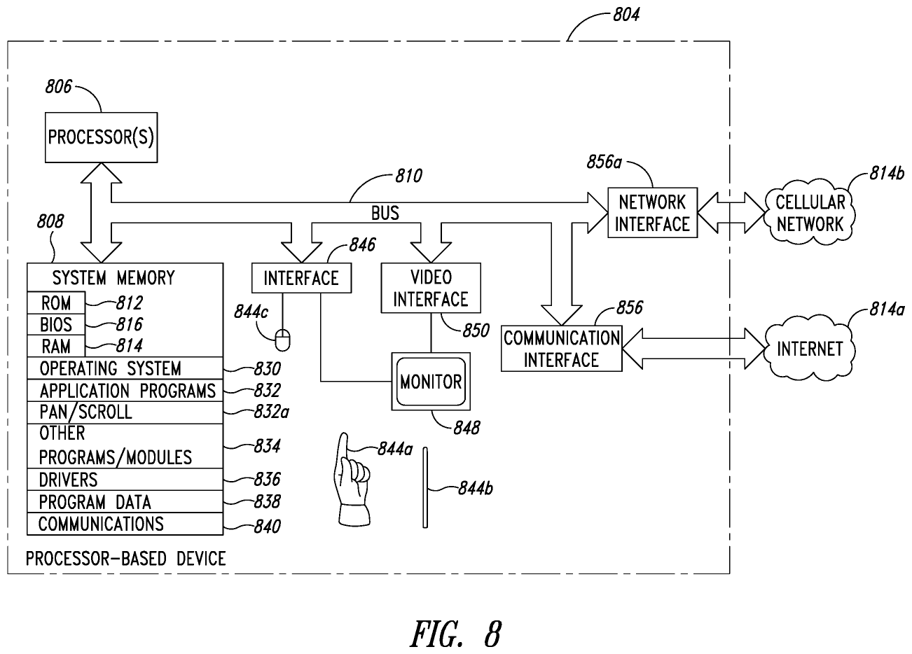

FIG. 8 shows a processor-based device 804 suitable for implementing the various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 804 may include one or more processors 806, a system memory 808 and a system bus 810 that couples various system components including the system memory 808 to the processor(s) 806. The processor-based device 804 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 806 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 8 are of conventional design. As a result, such blocks need not be described in further detail herein, as they will be understood by those skilled in the relevant art.

The system bus 810 can employ any known bus structures or architectures, including a memory bus with memory controller, a peripheral bus, and a local bus. The system memory 808 includes read-only memory (“ROM”) 812 and random access memory (“RAM”) 814. A basic input/output system (“BIOS”) 816, which can form part of the ROM 812, contains basic routines that help transfer information between elements within processor-based device 804, such as during start-up. Some implementations may employ separate buses for data, instructions and power.

The processor-based device 804 may also include one or more solid state memories, for instance Flash memory or solid state drive (SSD) 818, which provides nonvolatile storage of computer-readable instructions, data structures, program modules and other data for the processor-based device 804. Although not depicted, the processor-based device 804 can employ other nontransitory computer- or processor-readable media, for example a hard disk drive, an optical disk drive, or memory card media drive.

Program modules can be stored in the system memory 808, such as an operating system 830, one or more application programs 832, other programs or modules 834, drivers 836 and program data 838.

The application programs 832 may, for example, include panning/scrolling 832a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 832a may, for example, be stored as one or more executable instructions. The panning/scrolling logic 832a may include processor and/or machine executable logic or instructions to generate user interface objects using data that characterizes movement of a pointer, for example data from a touch-sensitive display or from a computer mouse or trackball, or other user interface device.

The system memory 808 may also include communications programs 840, for example a server and/or a Web client or browser for permitting the processor-based device 804 to access and exchange data with other systems such as user computing systems, Web sites on the Internet, corporate intranets, or other networks as described below. The communications programs 840 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 8 as being stored in the system memory 808, the operating system 830, application programs 832, other programs/modules 834, drivers 836, program data 838 and server and/or browser 840 can be stored on any other of a large variety of nontransitory processor-readable media (e.g., hard disk drive, optical disk drive, SSD and/or flash memory).

A user can enter commands and information via a pointer, for example through input devices such as a touch screen 848 via a finger 844a, stylus 844b, or via a computer mouse or trackball 844c which controls a cursor. Other input devices can include a microphone, joystick, game pad, tablet, scanner, biometric scanning device, etc. These and other input devices (i.e.,“I/O devices”) are connected to the processor(s) 806 through an interface 846 such as touch-screen controller and/or a universal serial bus (“USB”) interface that couples user input to the system bus 810, although other interfaces such as a parallel port, a game port or a wireless interface or a serial port may be used. The touch screen 848 can be coupled to the system bus 810 via a video interface 850, such as a video adapter to receive image data or image information for display via the touch screen 848. Although not shown, the processor-based device 804 can include other output devices, such as speakers, vibrator, haptic actuator, etc.

The processor-based device 804 may operate in a networked environment using one or more of the logical connections to communicate with one or more remote computers, servers and/or devices via one or more communications channels, for example, one or more networks 814a, 814b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 804 may include one or more wired or wireless communications interfaces 814a, 814b (e.g., cellular radios, WI-FI radios, Bluetooth radios) for establishing communications over the network, for instance the Internet 814a or cellular network.

In a networked environment, program modules, application programs, or data, or portions thereof, can be stored in a server computing system (not shown). Those skilled in the relevant art will recognize that the network connections shown in FIG. 8 are only some examples of ways of establishing communications between computers, and other connections may be used, including wirelessly.

For convenience, the processor(s) 806, system memory 808, network and communications interfaces 814a, 814b are illustrated as communicably coupled to each other via the system bus 810, thereby providing connectivity between the above-described components. In alternative implementations of the processor-based device 804, the above-described components may be communicably coupled in a different manner than illustrated in FIG. 8. For example, one or more of the above-described components may be directly coupled to other components, or may be coupled to each other, via intermediary components (not shown). In some implementations, system bus 810 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system to optimize advertisement placement in linear mediacasts for a seller of advertisements, the system comprising:
at least one nontransitory processor-readable storage medium that stores at least one of instructions or data; and
at least one processor communicatively coupled to the at least one nontransitory processor-readable storage medium, in operation, the at least one processor:
receives a request for an availability proposal for advertisement placement opportunities from a buyer, the request for the availability proposal including request criteria;
retrieves availability proposal information;
determines an optimized number of advertisement spots to offer to the buyer for each of a plurality of programs in each of one or more weeks, wherein, to determine the optimized number of advertisement spots to offer, the at least one processor:
generates an objective function that has as an objective the maximization of expected revenue uplift for the seller, the objective function having as decision variables the number of advertisement spots to offer for each of the plurality of programs in each of the one or more weeks;
generates one or more constraints defined by at least one of the request criteria or the availability proposal information; and
determines respective values for the decision variables that maximize the objective function subject to the one or more constraints;
presents, via a seller-facing interface, the determined values for the decision variables as the optimized number of advertisement spots to offer for each of a plurality of programs for each of the one or more weeks; and
sends an availability proposal to the buyer over a communication network, the availability proposal indicating the determined optimized number of advertisement spots offered.

2. The system of claim 1 wherein the objective function comprises a linear objective function.

3. The system of claim 1 wherein the objective function has an objective of rewarding proposed spots that have relatively few known or expected orders.

4. The system of claim 1 wherein the objective function has an objective of rewarding proposed spots that increase diversity with respect to at least one of daypart, week, or spot length.

5. The system of claim 1 wherein the one or more constraints comprises a constraint relating to an advertising impact goal of the buyer indicated in the request criteria.

6. The system of claim 5 wherein the one or more constraints comprises a plurality of constraints relating to daypart advertising impact goals of the buyer indicated in the request criteria.

7. The system of claim 1 wherein the one or more constraints comprises a constraint relating to a budget of the buyer indicated in the request criteria.

8. The system of claim 7 wherein the one or more constraints comprises a plurality of constraints relating to daypart budgets of the buyer indicated in the request criteria.

9. The system of claim 1 wherein the one or more constraints comprises a constraint relating to a maximum number of spots per half hour indicated in the request criteria.

10. The system of claim 1 wherein the request criteria includes one or more of a number of weeks to include in the availability proposal, eligible dayparts, eligible days, a budget, an advertising impact goal, a cost per rating point target, or spot length criteria.

11. The system of claim 1 wherein the availability proposal information comprises one or more of a rate for each program or a rating for each program.

12. The system of claim 1 wherein the availability proposal information comprises available demand forecast information for all eligible spots.

13. The system of claim 12 wherein the available demand forecast information is based at least in part on available orders and a rate guide for each eligible spot.

14. The system of claim 12 wherein the available demand forecast information is based at least in part on a global reserve price.

15. The system of claim 12 wherein the availability demand forecast information is determined based on the rates and spot lengths of all of the other orders that are eligible to be placed in the eligible spot.

16. The system of claim 1 wherein at least one of the request criteria or the availability proposal information specifies a maximum number of spots that can be offered for each program per day.

17. The system of claim 1 wherein at least one of the request criteria or the availability proposal information specifies a maximum number of spots that can be offered for each half-hour.

18. The system of claim 1 wherein at least one of the request criteria or the availability proposal information specifies a maximum number of spots that can be offered for each program per week.

19. The system of claim 1 wherein the availability proposal information specifies at least one of:
a configurable maximum number of spots that can be offered for each program per day; or
a configurable maximum number of spots that can be offered for each program per week.

20. The system of claim 1 wherein the objective function accounts for opportunity cost to maximize the expected revenue uplift for the seller.

21. The system of claim 1 wherein the request criteria of the availability request specifies at least one of hiatus date criteria, daypart criteria, program criteria, exclusion criteria, spot length criteria, and the one or more constraints accounts for the specified criteria.

22. A method of optimizing advertisement placement in linear mediacasts for a seller of advertisements, the method comprising:
receiving, by at least one processor, a request for an availability proposal for advertisement placement opportunities from a buyer, the request for the availability proposal including request criteria;
retrieving, by the at least one processor, availability proposal information;
determining, by the at least one processor, an optimized number of advertisement spots to offer to the buyer for each of a plurality of programs in each of one or more weeks by:
generating, by the at least one processor, an objective function that has as an objective the maximization of expected revenue uplift for the seller, the objective function having as decision variables the number of advertisement spots to offer for each of the plurality of programs in each of the one or more weeks;
generating, by the at least one processor, one or more constraints defined by at least one of the request criteria or the availability proposal information; and
determining, by the at least one processor, respective values for the decision variables that maximize the objective function subject to the one or more constraints;
presenting, by the at least one processor via a seller-facing interface, the determined values for the decision variables as the optimized number of advertisement spots to offer for each of a plurality of programs for each of the one or more weeks; and
sending, by the at least one processor, an availability proposal to the buyer over a communication network, the availability proposal indicating the determined optimized number of advertisement spots offered.

23. The method of claim 22 wherein generating an objective function comprises generating a linear objective function.

24. The method of claim 22 wherein generating an objective function comprises generating an objective function that has as an objective of rewarding proposed spots that have relatively few known or expected orders.

25. The method of claim 22 wherein generating an objective function comprises generating an objective function that has as an objective of rewarding proposed spots that increase diversity with respect to at least one of daypart, week, or spot length.

26. The method of claim 22 wherein generating one or more constraints comprises generating a constraint relating to an advertising impact goal of the buyer indicated in the request criteria.

27. The method of claim 26 wherein generating one or more constraints comprises generating a plurality of constraints relating to daypart advertising impact goals of the buyer indicated in the request criteria.

28. The method of claim 22 wherein generating one or more constraints comprises generating a constraint relating to a budget of the buyer indicated in the request criteria.

29. The method of claim 28 wherein generating one or more constraints comprises generating a plurality of constraints relating to daypart budgets of the buyer indicated in the request criteria.

30. The method of claim 22 wherein generating one or more constraints comprises generating a constraint relating to a maximum number of spots per half hour indicated in the request criteria.

31. The method of claim 22 wherein receiving a request for an availability proposal comprises receiving a request for an availability proposal that includes request criteria that includes one or more of a number of weeks to include in the availability proposal, eligible dayparts, eligible days, a budget, an advertising impact goal, a cost per rating point target, or spot length criteria.

32. The method of claim 22 wherein retrieving availability proposal information comprises retrieving availability proposal information that comprises one or more of a rate for each program or a rating for each program.

33. The method of claim 22 wherein retrieving availability proposal information comprises retrieving availability proposal information that comprises available demand forecast information for all eligible spots.

34. The method of claim 33 wherein retrieving availability proposal information comprises retrieving the available demand forecast information which is based at least in part on available orders and a rate guide for each eligible spot.

35. The method of claim 33 wherein retrieving availability proposal information comprises retrieving the available demand forecast information which is based at least in part on a global reserve price.

36. The method of claim 33 wherein the availability demand forecast information is determined based on the rates and spot lengths of all of the other orders that are eligible to be placed in the eligible spot.

37. The method of claim 22 wherein at least one of the request criteria or the availability proposal information specifies a maximum number of spots that can be offered for each program per day.

38. The method of claim 22 wherein at least one of the request criteria or the availability proposal information specifies a maximum number of spots that can be offered for each half hour.

39. The method of claim 22 wherein at least one of the request criteria or the availability proposal information specifies a maximum number of spots that can be offered for each program per week.

40. The method of claim 22 wherein the availability proposal information specifies at least one of:
a configurable maximum number of spots that can be offered for each program per day; or
a configurable maximum number of spots that can be offered for each program per week.

41. The method of claim 22 wherein the objective function accounts for opportunity cost to maximize the expected revenue uplift for the seller.

42. The method of claim 22 wherein the request criteria of the availability request specifies at least one of hiatus date criteria, daypart criteria, program criteria, exclusion criteria, spot length criteria, and the one or more constraints accounts for the specified criteria.

43. A nontransitory processor-readable storage medium that stores at least one of instructions or data, the at least one nontransitory processor-readable storage medium, when executed by at least one processor, cause the at least one processor to:
receive a request for an availability proposal for advertisement placement opportunities from a buyer, the request for the availability proposal including request criteria;
retrieve availability proposal information;
determine an optimized number of advertisement spots to offer to the buyer for each of a plurality of programs in each of one or more weeks, wherein, to determine the optimized number of advertisement spots to offer, the at least one processor:
generates an objective function that has as an objective the maximization of expected revenue uplift for the seller, the objective function having as decision variables the number of advertisement spots to offer for each of the plurality of programs in each of the one or more weeks;
generates one or more constraints defined by at least one of the request criteria or the availability proposal information; and
determines respective values for the decision variables that maximize the objective function subject to the one or more constraints;
present, via a seller-facing interface, the determined values for the decision variables as the optimized number of advertisement spots to offer for each of a plurality of programs for each of the one or more weeks; and
send an availability proposal to the buyer over a communication network, the availability proposal indicating the determined optimized number of advertisement spots offered.
